(19) United States
(12) Patent Application Publication
(10) Pub. No.: US 2010/0071996 A1
(43) Pub. Date: Mar. 25, 2010

(54) Collapsible platform ladder

(76) Inventor: Wen-Hung Huang, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,762

(22) Filed: Sep. 24, 2008

(51) Int. Cl. E06C 7/16; E04G 1/22

(52) U.S. Cl. 182/118

(57) ABSTRACT

The present invention is to provide a collapsible platform ladder, which comprises a pair platform decks, a pair ladder frames with telescopic hollow tubes and two pair collapsible floor feet, wherein the pair platform decks are abutted each other in linked way, the pair ladder frames are disposed on both distal outer lateral ends thereof respectively, and each pair pivotal floor feet are disposed at the ends for each ladder frame in pivotal manner respectively. In operation, telescopic hollow tubes of ladder frame can be pulled or retracted in different lengths to adjust working height, while in packing, floor feet are collapsed under ladder frames, ladder frames are collapsed under platform decks, platform decks are collapsed each other to become a compact collapsed ladder for easily storing and transportation

### FIELD OF THE INVENTION

The present invention provides a collapsible platform ladder, particularly for one can be adjustably retracted to enlarge working height during operation, and overall parts are collapsed to become a compact ladder while in packing for easily storing and transportation.

### BACKGROUND OF THE INVENTION

Generally speaking, being limited by the physical, human working at height place must resort to the ladder to ascend. Per inspection, the conventional ladder is normally constructed by a top board docked with a pair of ladder frames in pivotal manner, which must be expanded outwards in form of approximate “A”s shape while in operation to let user for climbing and ascending to a height of desire.

However, the top board of the conventional ladder aforesaid usually affords a small area for single user to stand only, so the active space of the user is extremely confined in the small top board. Besides, when horizontal displacement is required at work, the user must leave the ladder first for moving the ladder to the appropriate place so that the subsequent work can proceed continuously, which can be regarded as a seriously boring issue to the user.

Having realized the forgoing existing issues and drawbacks of the conventional ladder being never overcome, the inventor has undertaken research and development by addressing the issues and drawbacks as well as the ladder structure. After contrivance, test and constant improvement for a long time, eventually the present invention is worked out successfully.

### SUMMARY OF THE INVENTION

The primary object of the present invention is to provide a collapsible platform ladder, whose material can be can be selected from metal such as iron, steel, aluminum and rigid material such as fiberglass, carbonated fiber or plastics and the so on as well as finished square tube, flat tube or plumbing pipe.

The collapsible platform ladder of the present invention comprises a pair of platform decks, a pair of ladder frames and two pair of collapsible floor feet, wherein said pair of platform decks, which are abutted each other in linked way by each inner end thereof, comprises a pair of linking brackets disposed at the bottom side of the abutted inner end for linking each other, said pair of ladder frames are disposed on both distal outer lateral ends thereof respectively, and each pair of pivotal floor feet are disposed at the ends for each ladder frame in pivotal manner respectively.

The collapsible platform ladder accords with aforesaid one, wherein a buckling unit is disposed at a outer lateral side of the abutted inner end of said pair of platform decks, and includes a buckling hook and a buckling button thereat.

The collapsible platform ladder accords with aforesaid one, wherein a pair of rollers is respectively disposed at each distal outer end surface of said pair platform decks.

The collapsible platform ladder accords with aforesaid one, wherein said pair of ladder frames has a docking fixture disposed at each pivotal joint of the platform deck therewith, said docking fixture comprises a locking mount, which is firmly disposed in each of both platform deck 1 and includes an unlocking unit and a clipping unit, wherein said clipping unit, which is securely disposed on each of both top ends of the ladder frame to dock the platform deck with the ladder frame in locking manner, and said unlocking unit is to push inwards against the clipping unit off the locking mount so as to let the platform deck and ladder frame be able to pivot each other in unlocking manner;

The collapsible platform ladder accords with aforesaid one, wherein said pair of ladder frames comprises plural pair of hollow tubes with different diameters in telescopic sleeve way by each other, plural rung steps and plural jointers, wherein each circular wall of said hollow tubes has several latching holes created thereon, each of said rung steps crosses between corresponding pair of hollow tubes, and each of said jointers being to link each rung step onto corresponding hollow tube has a manipulator disposed therein; Said manipulator comprises an unlocking element, a pair of positioning pins, a reed and an elastic component, wherein each said positioning pin is to insert into the reed, said elastic component is disposed in the reed to push inwards against the positioning pin into a suitable latching hole of the hollow tube, and said unlocking element serves to push outwards against the positioning pin off the latching hole.

The collapsible platform ladder accords with aforesaid one, wherein each of said pair floor feet includes a foot body, a foot base and a pivotal shaft, wherein said foot body is securely disposed at the bottom end of the ladder frame in capping manner, and said foot base being capped by an anti-slip shoe is disposed beneath the bottom side of the foot body by the pivotal shaft in pivotal manner.

### BRIEF DESCRIPTION OF THE DRAWINGS

FIG. 1 is the perspective appearance schematic view of the present invention.

FIG. 2 is the perspective exploded schematic view of the present invention.

FIG. 3 is the perspective exploded schematic view showing the docking fixture of the present invention.

FIG. 4 is the perspective exploded schematic view showing the ladder frame of the present invention.

FIG. 5 is the front schematic view showing the whole ladder of the present invention.

FIG. 6 is the cross section schematic view taking along the line A-A from the previous FIG. 5.

FIG. 7 is the cross section schematic view taking along the line B-B from the previous FIG. 5.

FIG. 8 is the schematic view showing the first step in packing ladder of the present invention up.

FIG. 9 is the operational view for the manipulator of the ladder frame in the present invention.

FIG. 10 is the schematic view showing the second step in packing ladder of the present invention up.

FIG. 11 is the cross section schematic view showing the retracted state of the ladder frame for the present invention.

FIG. 12 is the operational view for the manipulator of the docking fixture in the present invention.

FIG. 13 is the schematic view showing the third step in packing ladder of the present invention up.

FIG. 14 is the schematic view showing the finish state for packing ladder of the present invention up.

### DETAILED DESCRIPTION OF THE PREFERRED EMBODIMENT

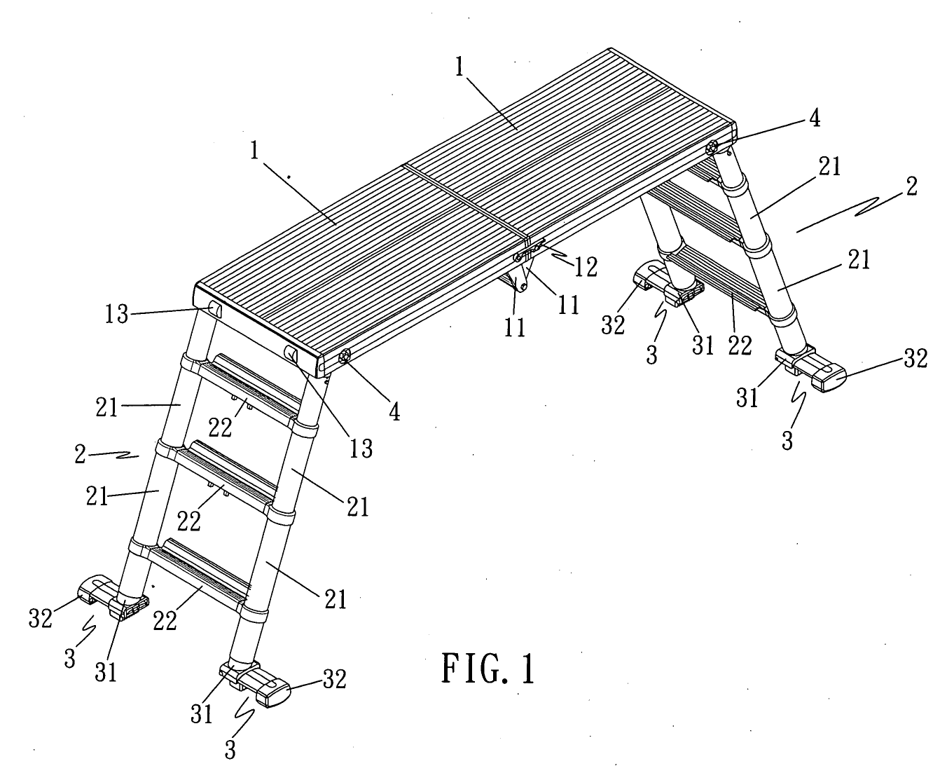

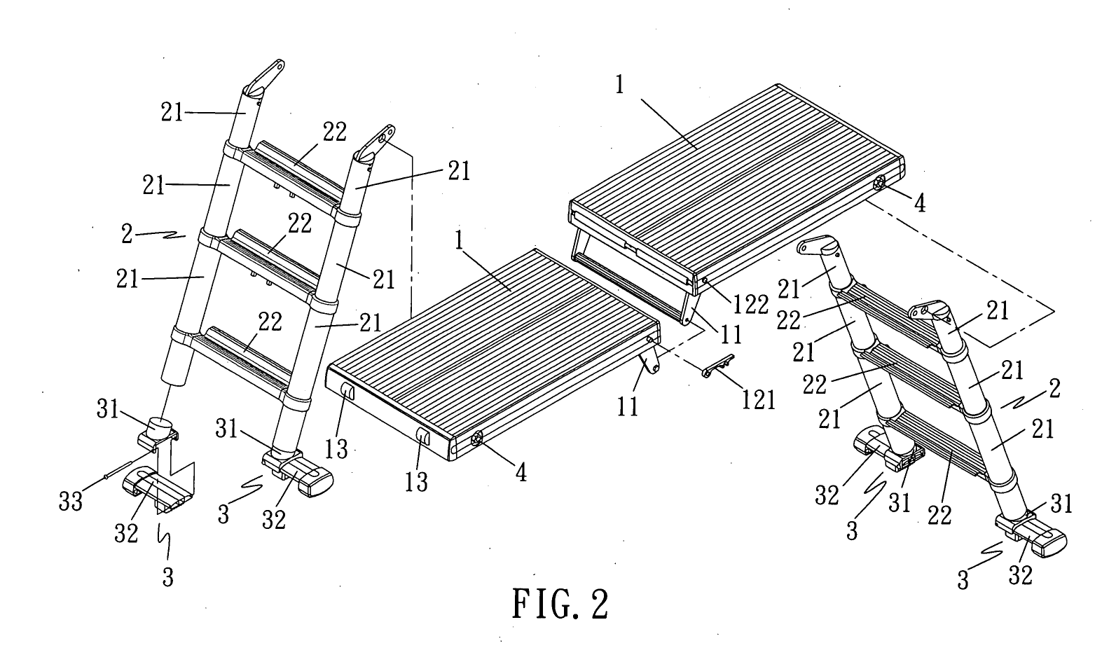

Regarding the technical means of the inventor, we here present a preferred exemplary embodiment with associated drawings to describe in detail manner for your better perusal, understanding and recognizing the present invention. Firstly, please refer to FIG. 1, which is the perspective appearance schematic view of the present invention, and FIGS. 2 through 4, which are the perspective exploded schematic views of the present invention.

The material for making the collapsible platform ladder of the present invention can be selected from metal such as iron, steel, aluminum and rigid material such as fiberglass, carbonated fiber or plastics and the so on as well as finished square tube, flat tube or plumbing pipe. The collapsible platform ladder comprises a pair of platform decks 1, a pair of ladder frames 2 and two pair of collapsible floor feet 3, wherein:

As shown in the FIG. 1, said pair of platform decks 1, which are abutted each other in linked way by each inner end thereof, comprises a pair of linking brackets 11, a buckling unit 12 and two pair of rollers 13, wherein said linking brackets 11 are disposed at the bottom side of the abutted inner end for linking each other, said buckling unit 12, which is disposed at a outer lateral side of the abutted inner end, includes a buckling hook 121 and a buckling button 122 thereat, and said pair of rollers 13 are respectively disposed at each distal outer end surface thereof;

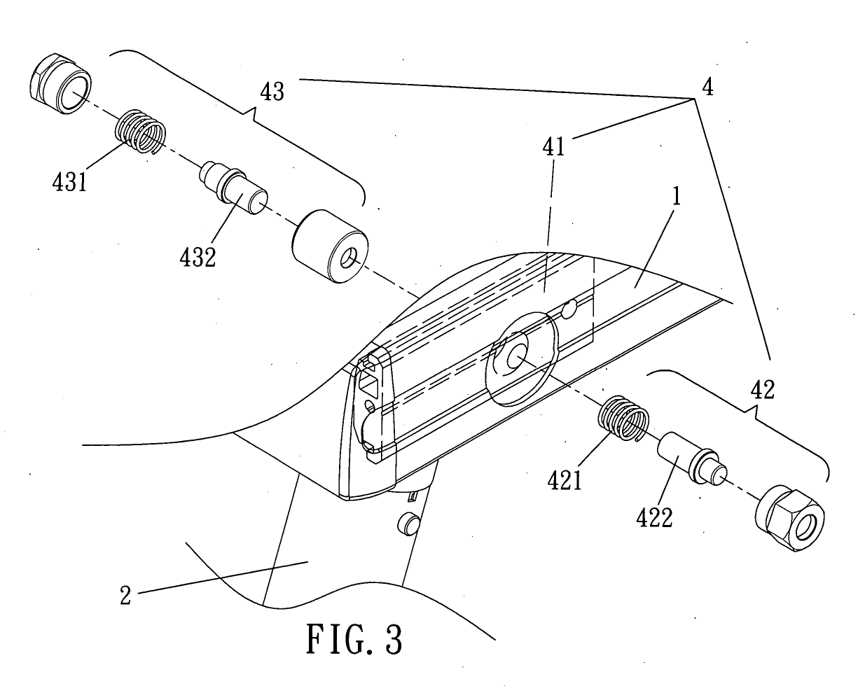

As shown in the FIGS. 2 and 3, said pair of ladder frames 2, which are disposed on both distal outer lateral ends thereof respectively, has a docking fixture 4 disposed at each pivotal joint of the platform deck 1 therewith;

As shown in the FIG. 3, said docking fixture 4 comprises a locking mount 41, which is firmly disposed in each of both lateral sides at distal outer end of the platform deck 1 and includes an unlocking unit 42 and a clipping unit 43, wherein said clipping unit 43, which is securely disposed on each of both top ends of the ladder frame 2 in corresponding to the unlocking unit 42, includes an elastic component 431 and a clipping pin 432, which is to insert into the locking mount 41 so as to dock the platform deck 1 with the ladder frame 2 in locking manner, and said unlocking unit 42 includes an elastic component 421 and a unlocking stem 422, which is to push inwards against the clipping pin 432 of the clipping unit 43 off the locking mount 41 so as to let the platform deck 1 and ladder frame 2 be able to pivot each other in unlocking manner;

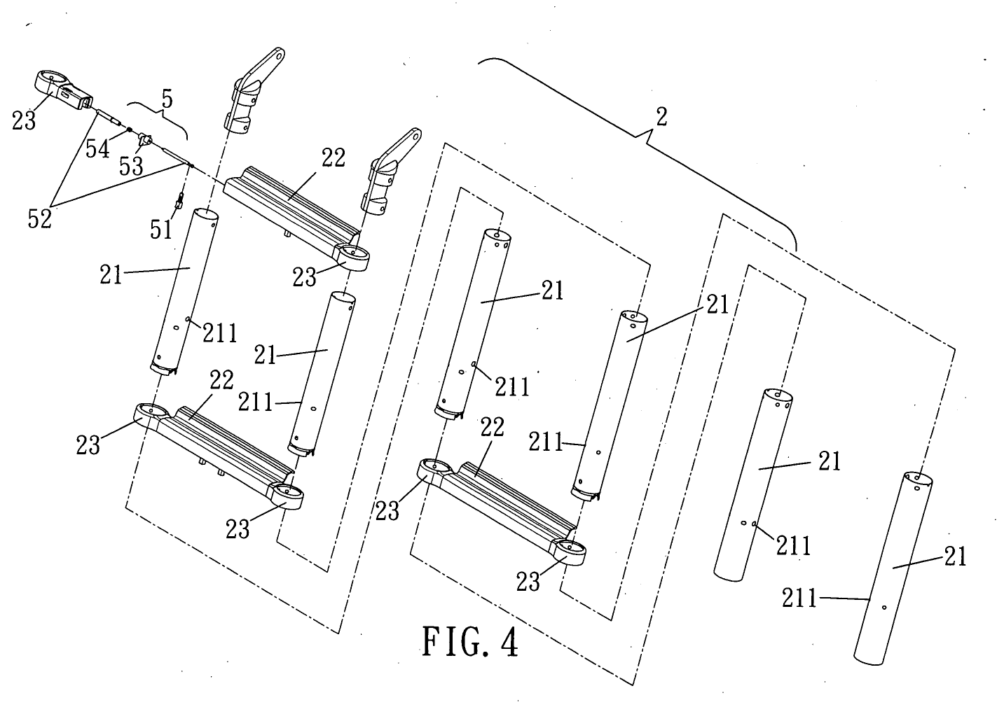

Besides, as shown in the FIG. 4, said pair of ladder frames 2 comprises plural pair of vertical hollow tubes 21 with different diameters in telescopic sleeve way by each other, plural rung steps 22 and plural jointers 23, wherein each circular wall of said hollow tubes 21 has several latching holes 211 created thereon, each of said rung steps 22 crosses between corresponding pair of hollow tubes 21, and each of said jointers 23 being to link each rung step 22 onto corresponding hollow tube 21 has a manipulator 5 disposed therein;

Said manipulator 5 comprises an unlocking element 51, a pair of positioning pin 52, a reed 53 and an elastic component 54, wherein each said positioning pin 52 is to insert into the reed 53 such that the inner one extends towards the center of the rung step 22 to joint with the unlocking element 51 while the outer one extends towards the hollow tube 21, said elastic component 54 is disposed in the reed 53 to push inwards against the positioning pin 5 into a suitable latching hole 211 of the hollow tube 21 so that the rung step 22 is linked onto corresponding pair of hollow tubes 21 in proper position, and said unlocking element 51 serves to push outwards against the positioning pin 52 off the latching hole 211; and

As shown in the FIG. 1, each of said pair floor feet 3 is securely disposed at the bottom end of each lowermost hollow tube 21 respectively, and includes a foot body 31, a foot base 32 and a pivotal shaft 33, wherein said foot body 31 is securely disposed at the bottom end of the ladder frame 2 in capping manner, and said foot base 32, which may be capped by an anti-slip shoe, is disposed beneath the bottom side of the foot body 31 by the pivotal shaft 33 in pivotal manner so that the foot base 32 can be inwards pivoted to opposite side against the ladder frame 2 for packing.

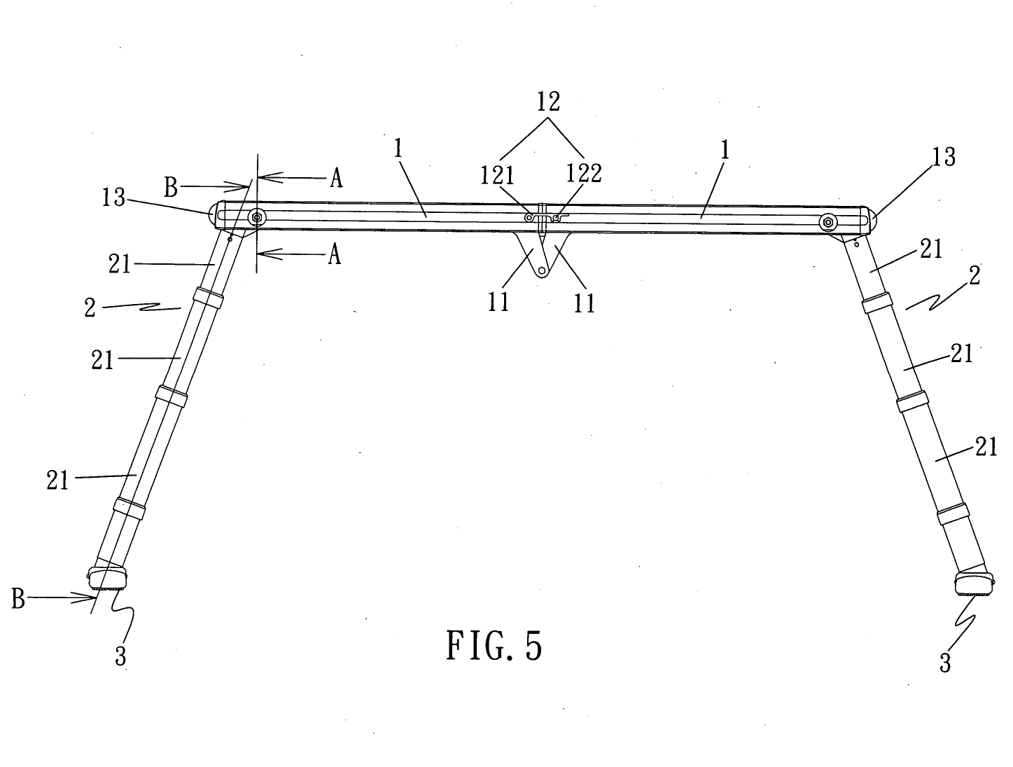

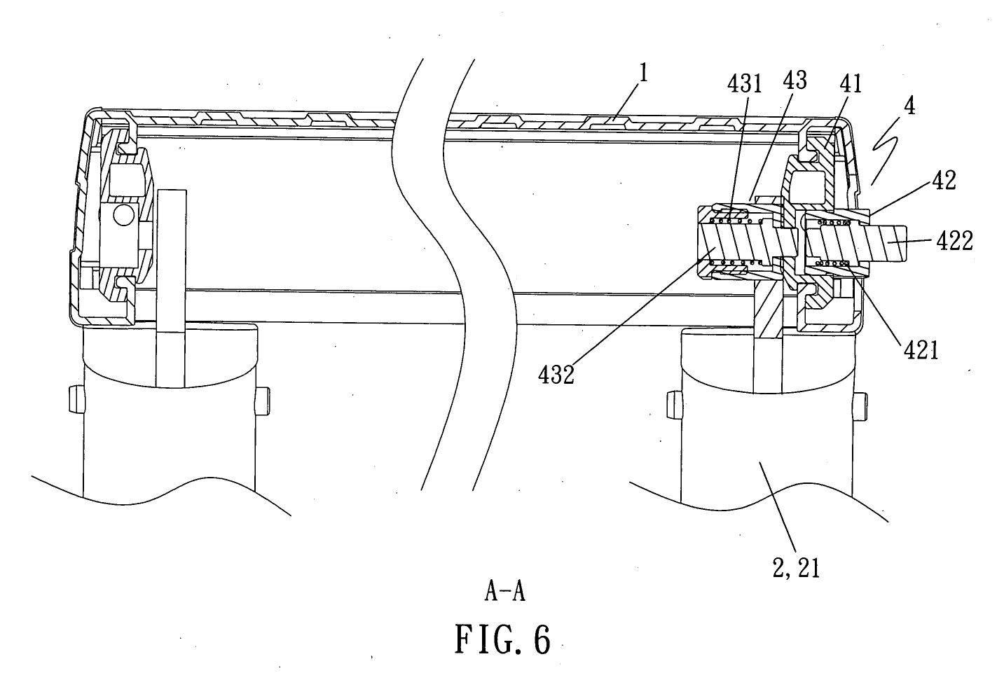

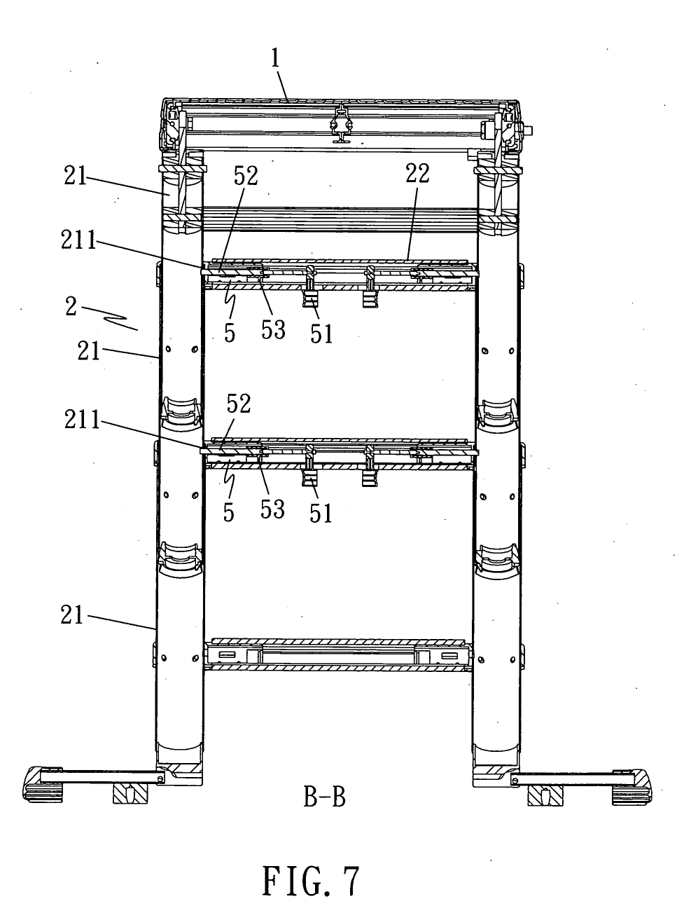

For assembling the platform ladder of the present invention, all the foregoing parts are combined and jointed together as shown in the FIGS. 1 and 5, wherein the pair of platform decks 1 are abutted each other in linked way by the buckling unit 12 via the buckling hook 121 directly catching the buckling button 122 so that the abutted manner between the pair of platform decks 1 is securely maintained without any possibility of pivot each other. Meanwhile, the pair of platform decks 1 and ladder frames 2 are docked each other by the docking fixture 4 via the elastic component 431 pushing inwards against the clipping pin 432 into the locking mount 41 as shown in the FIG. 6 so that both of the pair platform decks 1 and ladder frames 2 are maintained in securely locking manner and the ladder frames 2 are kept in open and stretching manner as shown in the FIG. 5. Regarding the assembling procedure of the ladder frame 2 mainly via the manipulator 5 in the jointer 23, please refer to the FIGS. 4 and 7. Each elastic component 54 of the manipulator 5 pushes inwards against positioning pin 52 into the latching hole 211 of the hollow tube 21 to latch the rung step 22 with the corresponding hollow tube 21.

For operating the platform ladder of the present invention, the height thereof can be adjusted to meet the requirement of the user. If the user wants to work at higher place, he/she can pull the telescopic hollow tube 21 of the ladder frame 2 in more or full extending manner and fix it by inserting the positioning pin 52 into suitable latching hole 211 of the hollow tube 21 so that the platform ladder is assembled at desired height in open and stretching manner as shown in the FIG. 1. Conversely, If the user wants to work at lower place, he/she can pull the telescopic hollow tube 21 of the ladder frame 2 in less or partial extending manner by the same token. Thus, the working space and range can be arbitrarily selected by the user to improve the working efficiency and convenience substantially, particularly being suitable for whitewashing wall, fixing wall fascia or car washing.

For packing the platform ladder after usage, the steps of the collapsing procedure are described below:

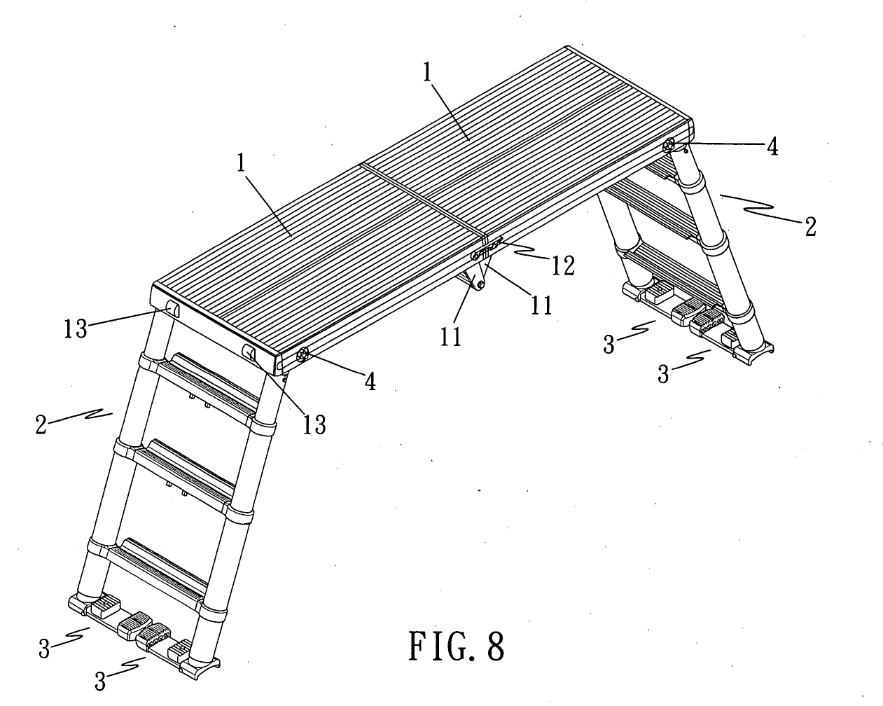

Step 1, Rotate the foot base 32 inwards around the pivotal shaft 33 so that the floor foot 3 is folded under the rung step 22 of the ladder frame 2 as shown in the FIG. 8;

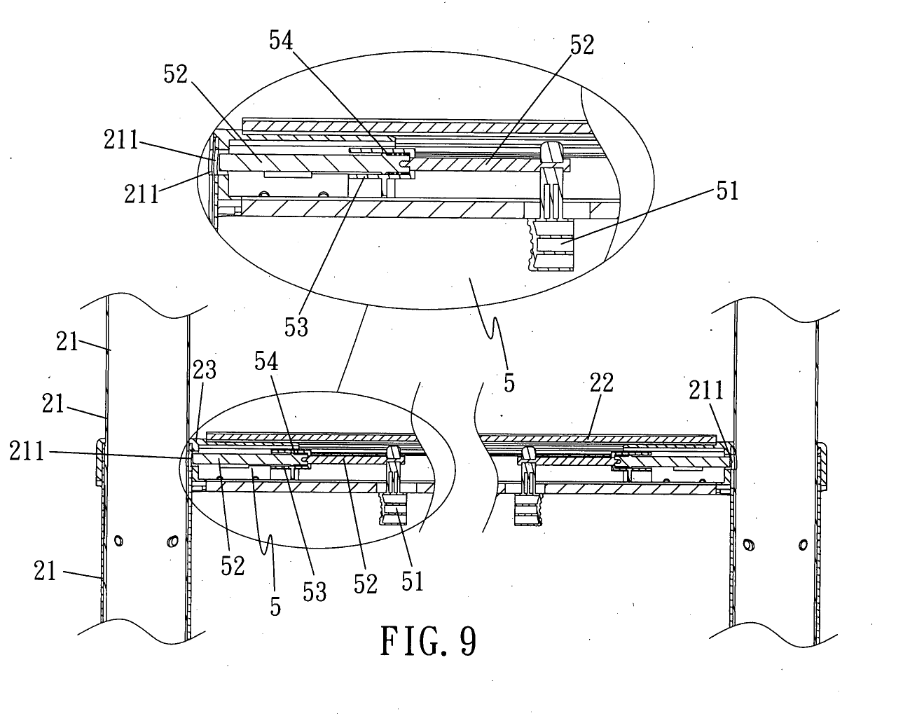

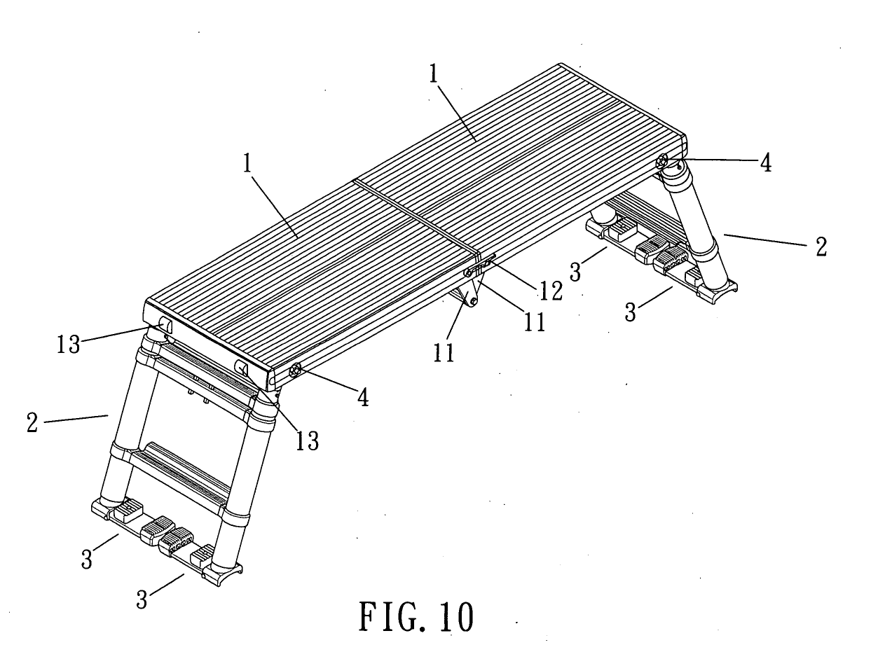

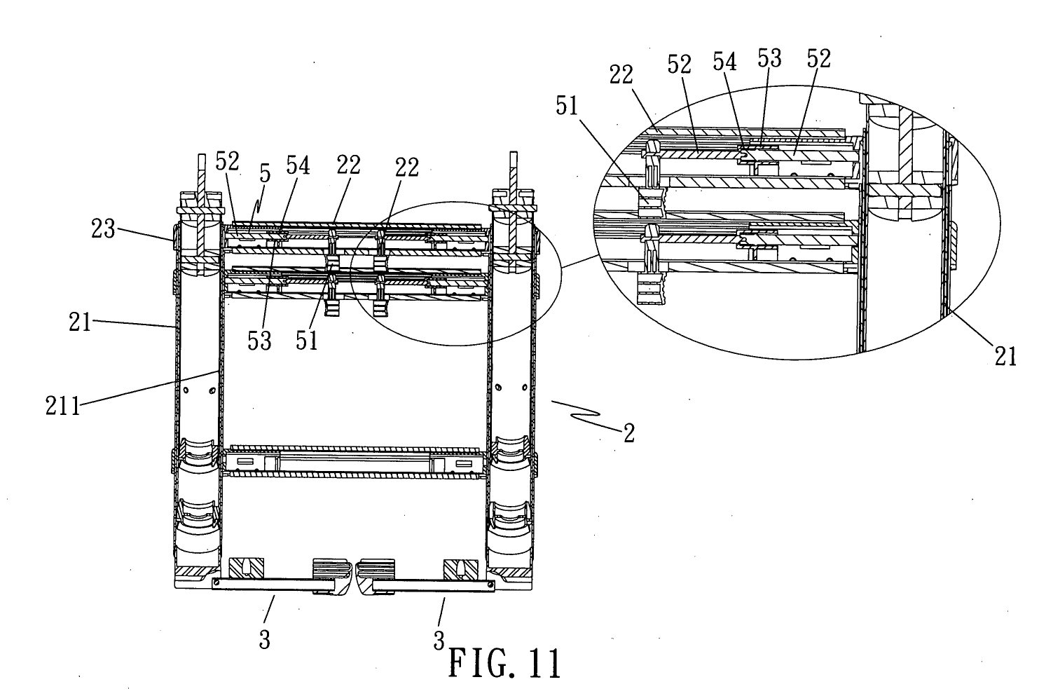

Step 2, Retract the length of the ladder frame 2 by simultaneously pushing both unlocking elements 51 in the middle of rung step 22 using single hand as shown in the FIG. 9 so that the positioning pins 52 are activated by the unlocking elements 51 to depart from the latching holes 211 of the corresponding hollow tubes 21 with resulting manner of collapsing the hollow tubes 21 and reducing the length of the ladder frame 2 as shown in the FIGS. 10 and 11;

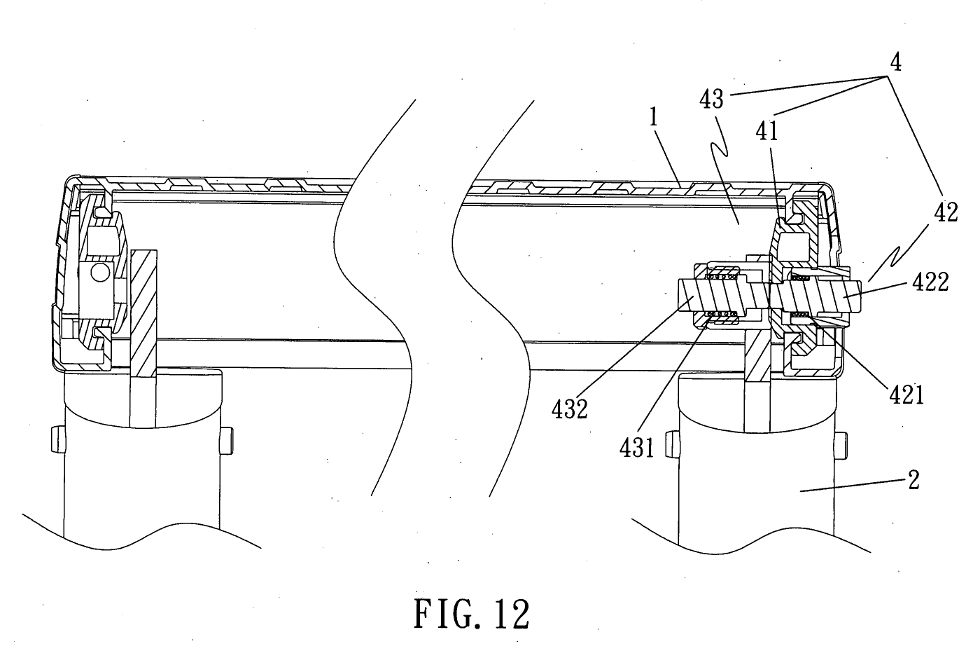

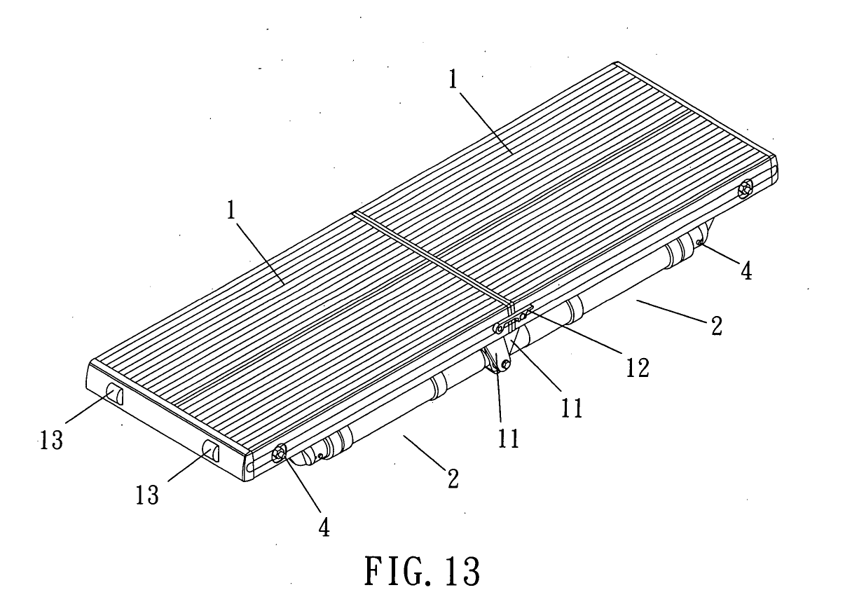

Step 3, Pivot and collapse two ladder frames 2 into state of being beneath the abutted platform decks 1 as shown in the FIG. 13 by simultaneously pushing both unlocking elements 42 in the docking fixtures 4 for activating unlocking stem 422 to push inwards against the clipping pin 432 of the clipping unit 43 to depart form the locking mount 41 as shown in the FIG. 12;

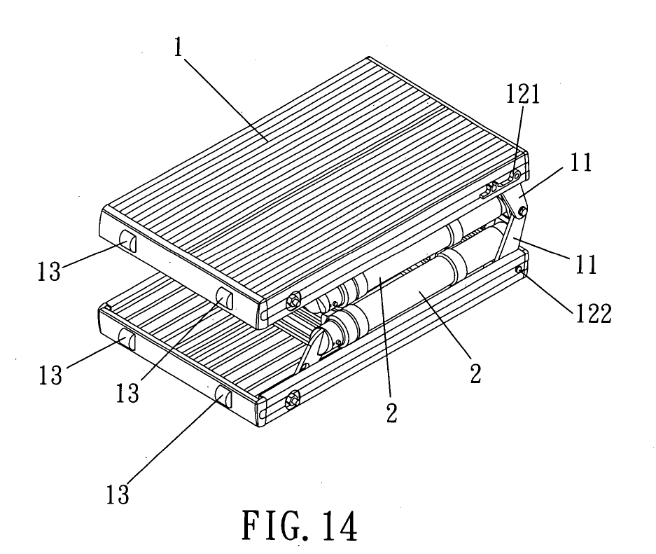

Step 4, Pivot and collapse two platform decks 1 around the linking brackets 11 joint towards each other as shown in the FIG. 14 by disjoining the buckling hook 121 of the buckling unit 12 away the buckling button 122 so that two platform decks 1 are free to pivot and collapse into compact manner; and finally the collapsed platform ladder becomes movable on the ground by means of the pair rollers 13 disposed at the end surface for each distal outer end of the platform deck 1 respectively such that the platform ladder has feature of mobility.

Basing on the disclosure heretofore, it is known that the platform ladder of the present invention has following advantages and effects:

### 1. Enlarge the Working Space:

Owing to the large area of the pair platform decks 1 in unfolding manner, the user can safely stand and walk thereon so that the working space is significantly enlarged to particularly be suitable for whitewashing wall, fixing wall fascia or car washing.

### 2. Facilitate the Operating and Collapsing:

The ladder frame 2 can be easily retracted into resulting manner of collapsing the hollow tubes 21 and reducing the length of the ladder frame 2 by simultaneously pushing both unlocking elements 51 in the middle of rung step 22 using single hand.

### 3. Reduce the Packing Size After Collapsing:

Owing to the telescopic collapsing feature in multi-section manner of the present invention, not only the collapsing and packing procedure is simple and quick but also the packing size is significantly reduced so that it is easily stored in the cabinet, under-bed space or car trunk.

### 4. Favor the Movement and Transportation:

Owing to the pair rollers 13 disposed at the end surface for each distal outer end of the platform deck 1 respectively, the collapsed platform ladder becomes movable on the ground with resulting effect of reducing the inconvenience during transportation and the burden of the physical strength.

### 5. Ease the Adjustment of the Working Height:

Because the ladder frame 2 of the present invention comprises plural pair of hollow tubes 21 with different diameters and they sleeve each other in telescopic way, the telescopic hollow tubes 21 can be pulled in more or full extending manner for ladder of longer length or retracted in less or partial extending manner for ladder of shorter length at the discretion of the user so that not only the working height can be easily adjusted but also more options in overall height are provided.

In conclusion, the structural features disclosed in the present invention, which do achieve the expected objects and effects, and have practical value and property of advancement that means the present invention meets the basic patentability criterion of novelty, non-obviousness and practical industrial usage. Accordingly, we submit the patent application in accordance with the related patent laws for your perusal and examination with expectation and appeal for approving us a patent grant, which will be greatly appreciated by us. However, all the disclosure and illustrations heretofore are only the exemplary preferred embodiments, which are not intended for limiting the range of the embodiment for the present invention. Therefore, any equivalent alteration or modification, which does not depart from the claim range and specification essence of the present invention, should be reckoned as in the claim range of the present invention.

What is claimed is:

1. A collapsible platform ladder, whose material is selected from metal of iron, steel, aluminum and rigid material of fiberglass, carbonated fiber or plastics as well as finished square tube, flat tube or plumbing pipe, comprises a pair of platform decks, a pair of ladder frames and two pair of collapsible floor feet, wherein the pair of platform decks, which are abutted each other in linked way by each inner end thereof, comprises a pair of linking brackets disposed at the bottom side of the abutted inner end for linking each other, the pair of ladder frames are disposed on both distal outer lateral ends thereof respectively, and each pair of pivotal floor feet are disposed at the ends for each ladder frame in pivotal manner respectively.

2. The collapsible platform ladder is recited and claimed as the claim 1, wherein a buckling unit is disposed at an outer lateral side of the abutted inner end of the pair of platform decks, and includes a buckling hook and a buckling button thereat.

3. The collapsible platform ladder is recited and claimed as the claim 1, wherein at least a pair of rollers is respectively disposed at each distal outer end surface of the pair platform decks.

4. The collapsible platform ladder is recited and claimed as the claim 1, wherein the pair of ladder frames has a docking fixture disposed at each pivotal joint of the platform deck therewith, the docking fixture comprises a locking mount, which is firmly disposed in each of both platform deck and includes an unlocking unit and a clipping unit, wherein the clipping unit, which is securely disposed on each of both top ends of the ladder frame to dock the platform deck with the ladder frame in locking manner, and the unlocking unit is to push inwards against the clipping unit off the locking mount so as to let the platform deck and ladder frame be able to pivot each other in unlocking manner;

5. The collapsible platform ladder is recited and claimed as the claim 1, wherein the pair of ladder frames comprises plural pair of hollow tubes with different diameters in telescopic sleeve way by each other, plural rung steps and plural jointers, wherein each circular wall of the hollow tubes has several latching holes created thereon, each of the rung steps crosses between corresponding pair of hollow tubes, and each of the jointers being to link each rung step onto corresponding hollow tube has a manipulator disposed therein; The manipulator comprises an unlocking element, a pair of positioning pins, a reed and an elastic component, wherein each positioning pin is to insert into the reed, the elastic component is disposed in the reed to push inwards against the positioning pin into a suitable latching hole of the hollow tube, and the unlocking element serves to push outwards against the positioning pin off the latching hole.

6. The collapsible platform ladder is recited and claimed as the claim 1, wherein each of the pair floor feet includes a foot body, a foot base and a pivotal shaft, wherein the foot body is securely disposed at the bottom end of the ladder frame in capping manner, and the foot base being capped by an anti-slip shoe is disposed beneath the bottom side of the foot body by the pivotal shaft in pivotal manner.
